(19) United States
(12) Patent Application Publication
(10) Pub. No.: US 2026/0365243 A1
(43) Pub. Date: Nov. 19, 2026

(54) Axle Carrier for a Two-Track Motor Vehicle

(71) Applicant: Bayerische Motoren Werke Aktiengesellschaft, Muenchen (DE)

(72) Inventor: Thomas DUERRSCHMID, Muenchen (DE)

(21) Appl. No.: 19/136,346

(22) PCT Filed: Nov. 27, 2023
(86) PCT No.: PCT/DE2023/100919

§ 371 Date: Jun. 6, 2025

(30) Foreign Application Priority Data
Dec. 21, 2022 (DE) 10 2022 134 413.4

(51) Int. Cl. B62D 21/11

(52) U.S. Cl. CPC B62D 21/11

(57) ABSTRACT

An axle carrier for a two-track motor vehicle has a number of tubular carrier components, wherein a number of vehicle components are able to be attached to respective tubular carrier components of at least some of the number of tubular carrier components. To attach a particular vehicle component of at least some of the number of vehicle components, an attachment structure having one or more attachment lugs is provided on the particular tubular carrier component. Each particular attachment lug has an attachment portion which is provided externally on the particular tubular carrier component for fastening the vehicle component. The axle carrier is characterized in that each particular attachment lug includes an insertion portion which is inserted into the interior of the particular tubular carrier component. An open region is provided on the particular tubular carrier component such that a surface region of the insertion portion exhibits an overlap with the open region. An edge of the open region is integrally joined, at least in sections, to the surface region of the insertion portion.

### BACKGROUND AND SUMMARY

The invention relates to an axle carrier for a two-track motor vehicle.

Vehicle components, such as a wheel-guiding link, are coupled to a motor vehicle via axle carriers, for example a front axle carrier or a rear axle carrier. For this purpose, the axle carrier comprises attachment lugs, which are provided on a corresponding carrier component of the axle carrier, such as a longitudinal member or a cross member. Usually, these attachment lugs are connected to the carrier component subsequently, for example by welding.

To achieve stiffness targets relating to driving dynamics and acoustics demands and strength targets, in particular relating to the service life, it is necessary to attach the attachment lugs to the carrier component as stiffly as possible. Sufficient stiffness is often not achieved by simply welding the attachment lugs to the carrier component. Therefore, attempts have been made in the prior art to improve the connection of the attachment lugs to the carrier component using a support plate.

For example, document DE 10 2020 125 974 A1 discloses an axle carrier in which the attachment lug, in addition to direct welding, is attached to a longitudinal member via a support plate, which is welded to the attachment lug. Even when a support plate is used, cracks can occur in the carrier component or in the weld seams as a result of the high force effect of the attached vehicle component.

It is the object of the invention to create an axle carrier for a two-track motor vehicle, which axle carrier improves the attachment of the axle carrier to a vehicle component.

This object is achieved by the axle carrier according to the independent claim(s). Developments of the invention are defined in the dependent claims.

The axle carrier according to the invention, which is intended for a two-track motor vehicle, comprises a number of tubular carrier components (i.e., at least one tubular carrier component), wherein a number of vehicle components (i.e., at least one component of the motor vehicle) can be attached to a particular tubular carrier component of at least some of the number of tubular carrier components. To attach a particular vehicle component of at least some of the number of vehicle components, an attachment structure comprising one or more attachment lugs is provided on the particular tubular carrier component. Each attachment lug comprises an attachment portion, which is provided externally on the particular tubular carrier component for fastening the vehicle component. Preferably, the attachment structure comprises a pair of attachment lugs, wherein an end of the vehicle component to be attached is arranged between the attachment portions of the two attachment lugs and is connected there to the attachment portions, for example via a screw fastening.

The axle carrier according to the invention is characterized in that each attachment lug comprises an insertion portion, which is inserted into the interior of the particular tubular carrier component, i.e., the particular tubular carrier component has a corresponding opening via which the insertion portion protrudes into the interior of the carrier component. The insertion portion is preferably arranged adjacently to the attachment portion. Furthermore, an open region is provided on the particular tubular carrier component such that a surface region of the insertion portion has an overlap with the open region. Since the surface region belongs to the insertion portion, this surface region is in the interior of the carrier component. An edge of the open region is integrally joined, at least in some portions, to the surface region of the insertion portion. In one variant, the surface region only overlaps with a part of the open region. In a further embodiment, the surface region overlaps with the entire open region. Preferably, the open region is elongate, wherein the longitudinal direction of the open region preferably extends in the direction in which the insertion component is inserted into the carrier component.

The axle carrier according to the invention has the advantage that the stability of the connection between the attachment lug and the carrier component is improved by an insertion portion in the interior of the carrier component and a corresponding integral join on the insertion portion. In particular, the integral join is provided further away from the attachment portion via which the force of the vehicle component is introduced into the attachment lug. Furthermore, the insertion portion stiffens the interior of the carrier component. Furthermore, no additional installation space is needed for the insertion portion, since the insertion portion is arranged in the interior of the particular tubular carrier component.

The integral join between the edge of the open region and the surface region of the insertion portion can be designed differently depending on the embodiment. In a particularly preferred variant, the edge of the open region is welded in at least some portions to the surface region of the insertion portion. Alternatively or additionally, the integral join can also be formed by adhesive bonding, soldering and the like.

In a particularly preferred embodiment of the axle carrier according to the invention, the attachment portion has a wall that is arranged in a predefined plane along which force is introduced from the vehicle component into the attachment portion when the vehicle component is fastened to the attachment portion, wherein the integral join via which the edge of the open region is connected at least in some portions to the surface region of the insertion portion has at least one connection seam and in particular at least one weld seam that extends in or parallel to the predefined plane. In this way, optimized introduction of force along the connection seam is achieved.

In a further preferred embodiment, the open region is provided on a predefined wall of the particular tubular carrier component, wherein the predefined wall is adjacent to a wall of the particular tubular carrier component via which the insertion portion is inserted into the carrier component. Advantageous introduction of force into the carrier component is thereby achieved. Preferably, the predefined wall is a horizontal wall, i.e., the wall runs in a horizontal direction (i.e., perpendicularly to gravity) when the particular tubular carrier component is installed in the motor vehicle.

In a further preferred embodiment, the insertion portion is one arm of a pair of arms, wherein the other arm of the pair is preferably integrally joined and in particular welded to the outside of the particular tubular carrier component. The connection between the attachment lug and the carrier component is thereby improved further.

In a further variant of the axle carrier according to the invention, the open region is an opening having a continuous edge in the particular tubular carrier component. Particularly good introduction of the forces exerted via the vehicle component is then achieved when the entire continuous edge of the opening is integrally joined and in particular welded to the surface region of the insertion portion.

In an alternative embodiment, instead of providing an opening with a continuous edge as the open region, the open region can also be formed by an indentation on an edge of a wall of the particular tubular carrier component, wherein the indentation is preferably adjacent to the attachment portion.

In a further variant of the axle carrier according to the invention, a support plate is provided on the particular tubular carrier component, on which support plate the attachment portion is supported and to which the attachment portion is integrally joined and preferably welded. Such a support plate is disclosed for example in document DE 10 2020 125 974 A1, which is cited in the introduction. Preferably, the support plate is formed integrally with the carrier component, but it can also be welded to the carrier component if necessary.

In a further preferred embodiment, the above-described indentation is adjacent to the support plate, wherein preferably a continuous connection seam is provided, via which both the edge of the open region is integrally joined and in particular welded at least in some portions to the surface region of the insertion portion and the attachment portion is integrally joined and in particular welded to the support plate. An integral join between the attachment lug and the carrier component can thereby be produced in a simple manner by means of a continuous connection seam.

The particular tubular carrier component of the axle carrier can be designed differently depending on the embodiment. For example, the carrier component can be a longitudinal member, which extends in the longitudinal direction of the motor vehicle when installed in the motor vehicle. The carrier component can likewise be a cross member, which extends in the vehicle transverse direction when installed in the motor vehicle. Furthermore, the particular tubular carrier component can be formed as a single piece, at least in a region in which the attachment structure is provided. It is likewise possible for the carrier component to be formed in multiple pieces, for example consisting of a lower shell and an upper shell, at least in the region in which the attachment structure is provided.

The axle carrier according to the invention can be provided for the attachment of different vehicle components. In particular, at least one attachment lug of the attachment lugs provided on the carrier component can be designed for the attachment of a vehicle component in the form of a wheel-guiding link for connecting a wheel of the motor vehicle to the axle carrier. At least one attachment lug can likewise be designed for the attachment of a vehicle component in the form of a pull rod and/or push rod for connecting a wheel of the motor vehicle to the axle carrier. Furthermore, at least one attachment lug can be designed for the attachment of a vehicle component in the form of an element, in particular an engine pendulum support, for connecting a drive assembly of the motor vehicle to the axle carrier.

In addition to the above-described axle carrier, the invention relates to a motor vehicle that comprises one or more axle carriers according to the invention or according to one or more preferred embodiments of the invention.

Exemplary embodiments of the invention are described in detail below with reference to the attached figures.

### BRIEF DESCRIPTION OF DRAWINGS

FIG. 1 is a plan view from above that shows a variant of an axle carrier according to the invention;

FIGS. 2 to 4 are perspective detail views of an attachment lug according to a first embodiment of the invention;

FIGS. 5 and 6 are perspective detail views of an attachment lug according to a second embodiment of the invention;

FIG. 7 is a plan view from below of the attachment lug of FIGS. 5 and 6;

FIGS. 8 and 9 are perspective detail views of a pair of attachment lugs according to a third embodiment of the invention; and

FIG. 10 is a plan view from below of the pair of attachment lugs of FIGS. 8 and 9.

### DETAILED DESCRIPTION OF DRAWINGS

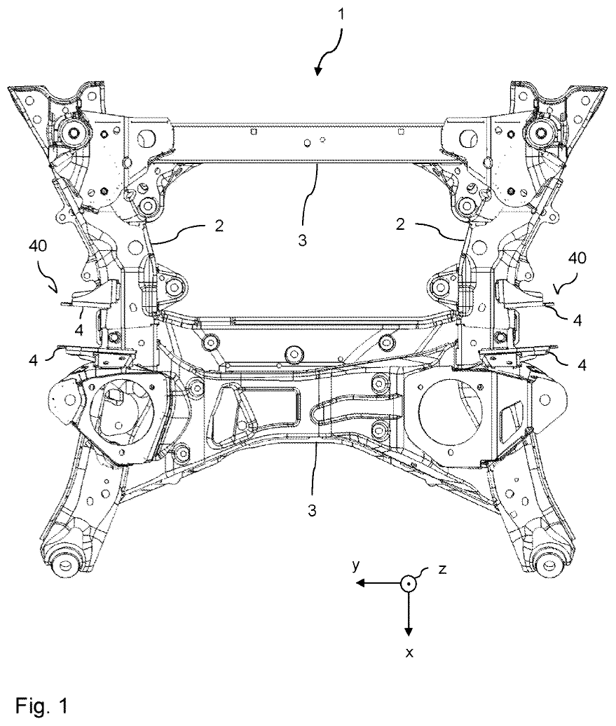

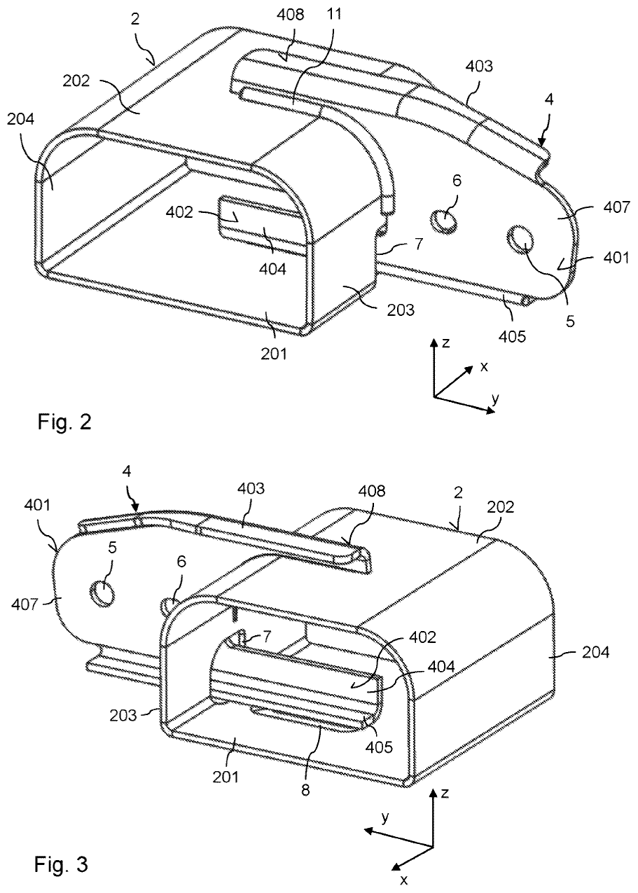

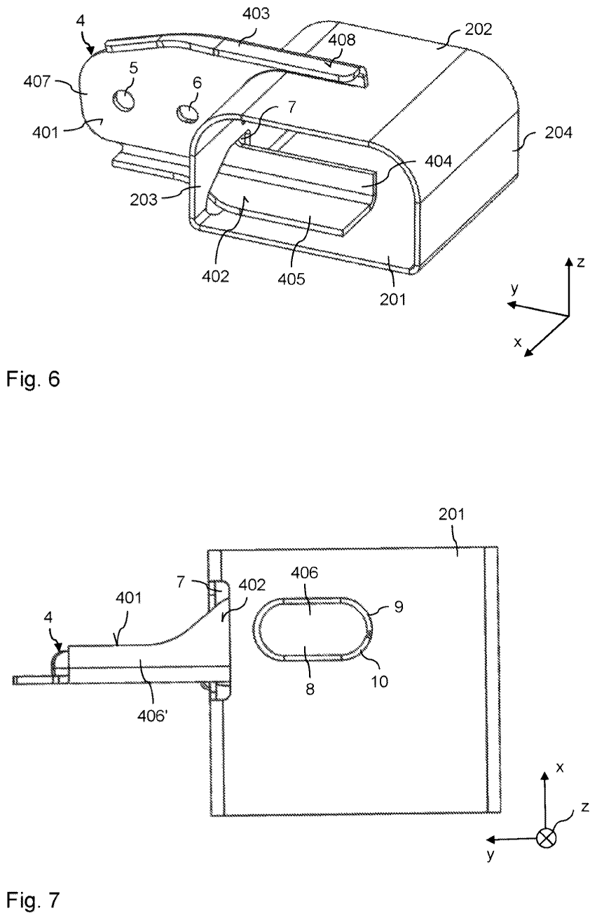

Embodiments of the invention are described below with reference to the axle carrier 1 shown in FIG. 1. A Cartesian coordinate system with x, y and z axes is shown in FIG. 1 and also in the other FIGS. 2 to 10. This coordinate system indicates the spatial directions in the corresponding figures. The x axis corresponds to the longitudinal direction of the motor vehicle, the y axis is the transverse direction of the motor vehicle, and the z axis is the vertical direction of the motor vehicle.

The axle carrier 1 comprises two longitudinal members 2 and two cross members 3, wherein each longitudinal member comprises an attachment structure 40, which contains a pair of attachment lugs 4 in each case. In each case, a lower transverse link of a wheel suspension is connected to one of the longitudinal members 2 via these attachment structures. The head of the transverse link is positioned between the attachment lugs 4 of the corresponding pair and screw-fastened to these attachment lugs in a manner known per se.

In the embodiment described here, the longitudinal member is a carrier component within the meaning of the claims. The invention is not limited to the attachment of a transverse link to a corresponding longitudinal member. In particular, the attachment structure 40 described below can also be used for the attachment of a longitudinal link or a pull rod and/or push rod or a link for connecting a drive assembly (e.g. engine pendulum support) to the axle carrier, wherein the attachment can also be made to a portion other than the longitudinal member, such as the cross member 3. The attachment lugs shown in FIG. 1 correspond to the attachment lugs according to the third embodiment described further below. Nevertheless, these attachment lugs can also be designed according to the first and second embodiments explained below.

FIGS. 2 to 4 show perspective views of a first embodiment of an attachment lug 4, wherein a section of the longitudinal member 2 is shown. In the exemplary embodiment shown, the longitudinal member 2 is an integral tubular component with a lower horizontal wall 201, an upper horizontal wall 202 and two vertical walls 203 and 204. The attachment lug 4 is arranged on the wall 203 and, in contrast to the prior art, is inserted into the longitudinal member 2. For this purpose, an opening 7 is provided in the wall 203, via which opening a part of the attachment lug 4 is inserted into the interior of the longitudinal member 2, as explained in more detail further below.

The attachment lug 4 comprises an attachment portion 401 with a vertical wall 407, which extends in the transverse direction of the motor vehicle and in which holes 5 and 6 are provided. The hole 6 is provided purely for manufacturing reasons, whereas the corresponding transverse link is fastened by means of a screw via the hole 5. For this purpose, a second attachment lug corresponding to FIG. 1 is provided, which is not shown in FIG. 2 or in the further FIGS. 3 to 7. The head of the transverse link is arranged and screw-fastened between these attachment lugs, wherein the head has a through-hole, through which the corresponding screw extends, for this purpose.

Furthermore, a lower, horizontally running wall 405 and an upper, partially horizontally and partially slightly obliquely running wall 403 are provided on the attachment lug 4. Both walls are connected integrally to the rest of the attachment lug 4 and formed by means of a sheet metal bending process or deep-drawing process. The rear region of the upper wall 403 belongs to an upper arm 408, the underside of which bears against the outside of the longitudinal member 2. As can be seen in FIG. 2, the arm 408 is welded to the outside of the longitudinal member 2 via a weld seam 11.

As can be seen particularly well in the perspective diagram of FIG. 3, a lower arm in the form of an insertion portion 402 is provided on the attachment lug 4 in addition to the upper arm 408. This insertion portion 402 comprises a vertically running wall 404 and a portion of the horizontal wall 405, which partially covers an open region 8 in the form of an elongate opening provided in the lower wall 201 of the longitudinal member 2. The opening 8 with its circumferential edge 9 can be seen very well in FIG. 4.

It can also be seen in FIG. 4 that the horizontal wall 405 comprises a lower surface region 406, which is arranged in the interior of the longitudinal member 2 and thus belongs to the insertion portion 402. Furthermore, the horizontal wall 405 has a further lower surface region 406′, which is provided outside the longitudinal member 2 and thus belongs to the attachment portion 401. The surface region 406 partially covers the elongate opening 8, which runs in the vehicle transverse direction. Via the opening 8, the insertion portion 402 and thus the attachment lug 4 are connected to the longitudinal member 2 by means of the weld seam 10, which extends in the transverse direction or the plane in which the horizontal wall 407 of the attachment portion 401 is arranged. Via this welded connection, the attachment lug 4 is connected to the longitudinal member 2 far away from the attachment point of the transverse link, as a result of which the stability of the connection between the attachment lug and the longitudinal member is increased.

Furthermore, the weld seam extending in the vehicle transverse direction allows very good introduction of the force exerted by the transverse link into the lower horizontal wall 201 and not into the vertical walls 203, 204, which can absorb forces poorly in the vehicle transverse direction. This is illustrated again by the force flow shown in FIG. 4. In this figure, the arrow F indicates the force exerted by the attached transverse link. The resulting force flow within the attachment lug 4 or the longitudinal member 2 is also shown by dashed force lines L. As can be seen, the weld seam 10 extends in the plane in which the force F is introduced into the attachment portion 401, so that the force of the transverse link is directed very well into the lower wall 201.

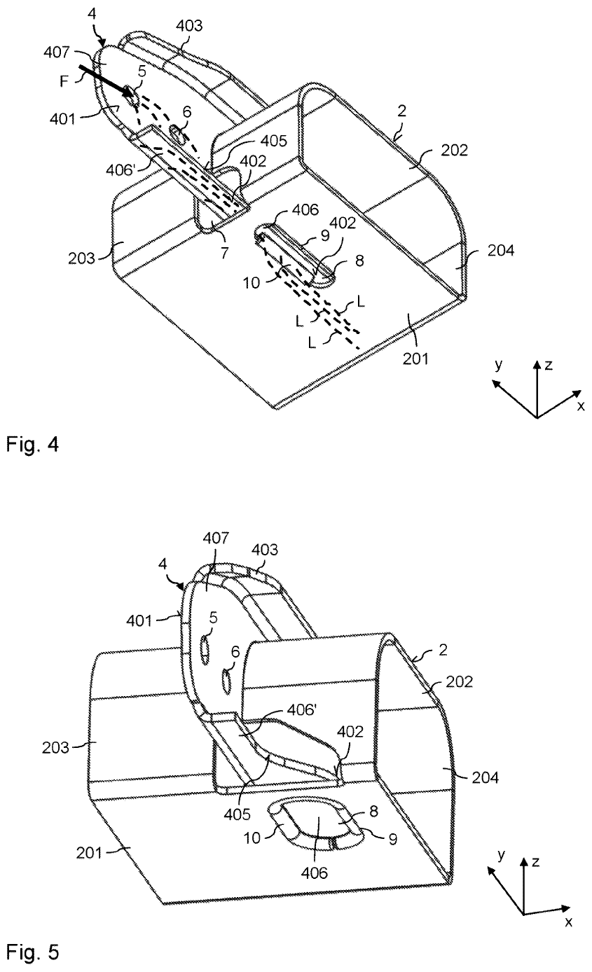

FIGS. 5 to 7 show a second embodiment of an attachment lug 4. In these figures, the same or corresponding components are denoted by the same reference signs as in the first embodiment according to FIGS. 2 to 4. The difference of the second embodiment from the first embodiment from FIGS. 2 to 4 consists in that the lower horizontal wall 405 is widened in the region that belongs to the insertion portion 402. In other words, this results in a lower surface region 406 that is wider in the vehicle longitudinal direction than the surface region in the embodiments from FIGS. 2 to 4.

Furthermore, the second embodiment differs from the first embodiment in that the elongate opening 8 is wider. This widening in combination with the wider surface region 406 makes it possible to form the weld seam 10 continuously around the opening 8, which is not possible in the first embodiment. The stability of the connection between the attachment lug 4 and the longitudinal member 2 is thereby improved further.

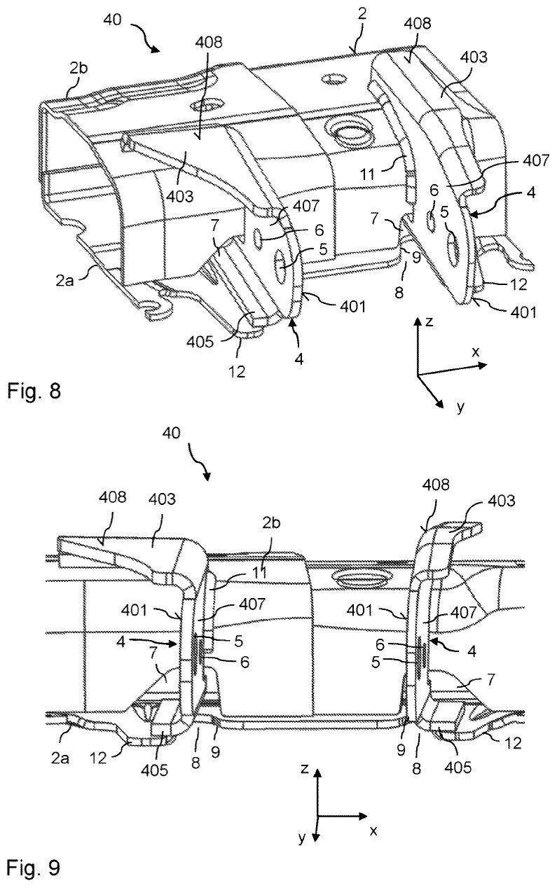

FIGS. 8 to 10 show views of a third embodiment of the invention, wherein the entire connection structure 40 consisting of a pair of two attachment lugs 4 is shown in these figures. The connection structure corresponds to the connection structure that is also shown in the diagram of FIG. 1. The same or corresponding components that are already shown in the preceding embodiments are again denoted by the same reference signs. The embodiment shown in FIGS. 8 to 10 differs from the preceding embodiments in that the longitudinal member 2 is now formed in two parts from a lower shell 2a and an upper shell 2b. Furthermore, the upper shell 2b is again divided at a position between the two attachment lugs 4.

The two attachment lugs 4 have the same construction except for the design of the upper horizontal wall 403. In particular, the upper horizontal wall in the attachment lug arranged on the left in FIG. 8 widens much more than the upper horizontal wall of the right-hand attachment lug in FIG. 8. The two attachment lugs 4 are again inserted into the longitudinal member 2 via corresponding openings 7. In contrast to the preceding embodiments, however, there is now no continuous opening for welding the insertion portion 402 to the longitudinal member 2. Instead, an indentation 8 is used, which is formed on the front edge of the lower shell 2a.

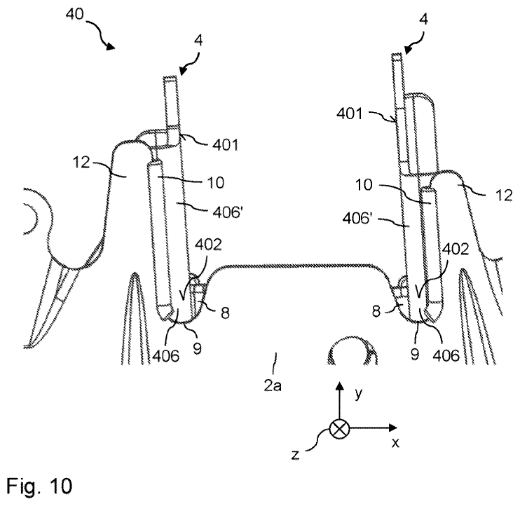

The two indentations 8 for the corresponding attachment lugs can be seen very well in FIG. 10, which shows a section of a plan view from below of the attachment lugs 4 and the lower shell 2a. In particular, it can be seen in FIG. 10 that a support plate 12 is provided adjacently to the respective indentations 8, which support plate is an integral part of the lower shell 2a and is used to support the attachment portion 401 in the vertical direction. As can be seen, a weld seam 10 is provided for each connection lug 4, wherein each weld seam continuously both connects the attachment portion 401 or its surface region 406′ to the support plate 12 and connects the insertion portion 402 or its surface region 406 to a part-portion of the edge 9 of the indentation 8. By means of the support plate 12 in combination with the continuous weld seam 10, which connects both the attachment portion 401 and the insertion portion 402 to the longitudinal member 2, very good introduction of force into the longitudinal member in the horizontal direction and a very stable connection between the attachment lug and the longitudinal member are achieved.

The embodiments of the invention described above have a series of advantages. In particular, a connection between an attachment lug and a carrier component in the form of a longitudinal member is achieved such that the forces are introduced ideally into the part of the carrier component that is stiffest in the loading direction. The attachment lug is attached both to a lower and an upper wall of the carrier component via welded connections. The insertion portion of the respective attachment lugs brings about a stiffening of the carrier component. The attachment lugs thus act like a stiffening plate. In comparison with an attachment lug that encloses the carrier component around its outer circumference, the required installation space in the vertical direction can be reduced by means of the attachment lugs with insertion portion. In confined installation space conditions, the extent of the carrier component in its vertical direction does not have to be limited to integrate a larger attachment lug.

With regard to the above-described second embodiment, the further advantage is achieved that a continuous annular weld seam with overlapping ends can be provided at the corresponding opening in the carrier component, as a result of which the stresses and forces can be introduced and distributed into the horizontal tubular surface of the carrier component over a larger area, and the stress peaks that otherwise occur through the ends of the weld seams can be eliminated.

Furthermore, the attachment lug with insertion portion according to the above-described third embodiment can also be combined with a support plate, which extends out of the carrier component. As a result, the weld seam for connecting the attachment lug to the carrier component is lengthened in comparison with an embodiment of a support plate with an attachment lug without an insertion portion. The lengthening means that the end of the weld seam remote from the transverse link is further away from the transverse link than the vertical outer wall of the carrier component. As a result, stress peaks at the weld seam on the underside of the carrier component are reduced, and the service life of the carrier component is thus lengthened. Moreover, the additional stiffening by the support plate provided has a positive effect on the stiffness of the transverse link attachment and improves the driving dynamics.

### LIST OF REFERENCE SIGNS

1 Axle carrier
2 Carrier component (longitudinal member)
201 Lower horizontal wall of carrier component
202 Upper horizontal wall of carrier component
203 Front vertical wall of carrier component
204 Rear vertical wall of carrier component
2a Lower shell
2b Upper shell
3 Cross member
40 Attachment structure
4 Attachment lug
401 Attachment portion
402 Insertion portion
403 Upper wall of attachment lug
404 Vertical wall of insertion portion
405 Lower wall of attachment lug
406, 406′ Surface regions of lower wall of attachment lug
407 Vertical wall of attachment portion
408 Upper arm of attachment lug
5,6 Openings in attachment portion
7 Opening in carrier component
8 Open region in carrier component
9 Edge of open region
10, 11 Weld seams
12 Support plate
F Force
L Force lines
x, y, z Spatial directions

1.-15. (canceled)

16. An axle carrier for a two-track motor vehicle, comprising:
a number of tubular carrier components, wherein a number of vehicle components are attachable to a particular tubular carrier component of at least some of the number of tubular carrier components;
an attachment structure comprising one or more attachment lugs provided on the particular tubular carrier component, wherein each attachment lug comprises an attachment portion, which attachment portion is provided externally on the particular tubular carrier component for fastening a vehicle component,
wherein each attachment lug comprises an insertion portion, which is inserted into an interior of the particular tubular carrier component,
wherein an open region is provided on the particular tubular carrier component such that a surface region of the insertion portion has an overlap with the open region, and
wherein an edge of the open region is integrally joined, at least in some portions, to the surface region of the insertion portion.

17. The axle carrier according to claim 16, wherein
the edge of the open region is welded in at least some portions to the surface region of the insertion portion.

18. The axle carrier according to claim 16, wherein
the attachment portion has a wall that is arranged in a predefined plane along which force is introduced from the vehicle component into the attachment portion when the vehicle component is fastened to the attachment portion, and
the integral join, via which the edge of the open region is connected at least in some portions to the surface region of the insertion portion, has at least one connection seam that extends in or parallel to the predefined plane.

19. The axle carrier according to claim 16, wherein
the open region is provided on a predefined wall of the particular tubular carrier component, and
the predefined wall is adjacent to a wall of the particular tubular carrier component via which the insertion portion is inserted into the particular carrier component.

20. The axle carrier according to claim 16, wherein
the insertion portion is one arm of a pair of arms, and
the other arm of the pair is integrally joined to an exterior of the particular tubular carrier component.

21. The axle carrier according to claim 16, wherein
the open region is an opening having a continuous edge in the particular tubular carrier component.

22. The axle carrier according to claim 21, wherein
an entire continuous edge of the opening is integrally joined to the surface region of the insertion portion.

23. The axle carrier according to claim 16, wherein
the open region is formed by an indentation on an edge of a wall of the particular carrier component, and
the indentation is adjacent to the attachment portion.

24. The axle carrier according to claim 16, further comprising:
a support plate provided on the particular tubular carrier component, on which support plate the attachment portion is supported and to which the attachment portion is integrally joined.

25. The axle carrier according to claim 24, wherein the support plate is formed integrally with the carrier component.

26. The axle carrier according to claim 24, wherein
the open region is formed by an indentation on an edge of a wall of the particular carrier component,
the indentation is adjacent to the attachment portion, and
a continuous connection seam is provided, via which both the edge of the open region is integrally joined at least in some portions to the surface region of the insertion portion and the attachment portion is integrally joined to the support plate.

27. The axle carrier according to claim 16, wherein
the particular tubular carrier component is a longitudinal member, which extends in a vehicle longitudinal direction when installed in the motor vehicle, or
the tubular carrier component is a cross member, which extends in a vehicle transverse direction when installed in the motor vehicle.

28. The axle carrier according to claim 16, wherein
the particular tubular carrier component is formed as a single piece or as multiple pieces, at least in the region in which the attachment structure is provided.

29. The axle carrier according to claim 16, wherein at least one of:
(i) at least one attachment lug is designed for the attachment of a vehicle component in the form of a wheel-guiding link for connecting a wheel of the motor vehicle to the axle carrier, or
(ii) at least one attachment lug is designed for the attachment of a vehicle component in the form of a pull rod and/or push rod for connecting a wheel of the motor vehicle to the axle carrier, or
(iii) at least one attachment lug is designed for the attachment of a vehicle component in the form of an engine pendulum support, for connecting a drive assembly of the motor vehicle to the axle carrier.

30. A motor vehicle comprising one or more axle carriers according to claim 16.
